(19) United States
(12) Patent Application Publication
(10) Pub. No.: US 2010/0122439 A1
(43) Pub. Date: May 20, 2010

(54) MOBILE DEVICE ATTACHMENT APPARATUS AND METHODS THEREOF

(76) Inventors: Ryan M. Britton, Atlantic Highlands, NJ (US); William D. Kilpatrick, Highlands, NJ (US)

Correspondence Address: MALDJIAN & FALLON LLC, 365 BROAD STREET, THIRD FLOOR, RED BANK, NJ, 07701, US

(21) Appl. No.: 12/619,837

(22) Filed: Nov. 17, 2009

Related U.S. Application Data
(60) Provisional application No. 61/115,970, filed on Nov. 19, 2008.

(51) Int. Cl. A44B 18/00; A44B 99/00; F16M 13/00; F16B 33/00

(52) U.S. Cl. 24/306; 24/1; 248/682; 24/304; 411/378

(57) ABSTRACT

Embodiments of the present invention relate to an article holding apparatus affixed to the exterior of a mobile device for conveniently retaining personal articles therein. In one embodiment of the present invention, a mobile device attachment apparatus comprises a securing surface for positioning the mobile device attachment apparatus against a surface of the mobile device, the securing surface having a securing means thereon, and an article retaining pocket for securely holding at least a removable article therein. In another embodiment, a mobile device attachment apparatus comprises a securing panel for positioning the mobile device attachment apparatus against a surface of the mobile device and for supporting an article retaining portion, the securing panel having a securing means thereon, wherein the an article retaining portion protrudes from the securing panel, adjacent to the mobile device, and securely holds at least a removable article therein.

### CROSS-REFERENCE TO RELATED APPLICATIONS

This application claims the benefit of U.S. Provisional Patent Application No. 61/115,970, entitled “Mobile Device Attachment Apparatus and Methods Thereof,” filed Nov. 19, 2008, the entire disclosure of which is incorporated herein by reference in its entirety.

### BACKGROUND OF THE INVENTION

1. Field of the Invention

Embodiments of the present invention generally relate to a mobile device attachment apparatus and methods of utilizing the same. More specifically, embodiments of the present invention relate to an article holding apparatus affixed to the exterior of a mobile device for conveniently retaining personal articles therein.

2. Description of Related Art

A large segment of the global population carries cell phones, iPods, PDAs, or other mobile devices of various configurations. Along with the device, most people also carry a key, a cigarette lighter, a pill carrier, a lipstick, or other small items. In most instances these items are thrown into a purse or carried in a pocket of a jacket or pants; hence one rarely knows where they may be located. However, almost everyone can instantly find a cell phone.

Attachments for cell phones or mobile phones have been around for nearly as long as the first publicly available mobile phones. These types of attachments consist of protective casings, belt clips or the like, used to protect the mobile phone and/or keep the mobile phone in a secure or semi-secure location. However, such existing attachments designed solely to support the mobile phone, and not a separable article.

Thus, there is a need for an improved mobile device attachment apparatus and methods thereof.

### SUMMARY

Embodiments of the present invention relate to an article holding apparatus affixed to the exterior of a mobile device for conveniently retaining personal articles therein. In one embodiment of the present invention, a mobile device attachment apparatus comprises a securing surface for positioning the mobile device attachment apparatus against a surface of the mobile device, the securing surface having a securing means thereon, and an article retaining pocket for securely holding at least a removable article therein.

In another embodiment, a mobile device attachment apparatus comprises a securing panel for positioning the mobile device attachment apparatus against a surface of the mobile device and for supporting an article retaining portion, the securing panel having a securing means thereon, wherein the an article retaining portion protrudes from the securing panel, adjacent to the mobile device, and securely holds at least a removable article therein.

In another embodiment of the present invention, a mobile device attachment apparatus comprises a securing panel for positioning the mobile device attachment apparatus against a surface of the mobile device and for supporting an article retaining bracket, the securing panel having a securing means thereon, wherein the an article retaining bracket provides a limited range of motion for an article secured therein.

In accordance with one exemplary embodiment of the present invention, a pouch/holder that easily attaches to the back of any mobile device (e.g., cell phone, iPod, Blackberry, etc.), via hook and look fasteners (i.e., Velcro), clear stick adhesive or the like, enables a user to place items into the holder and retain easy access without losing such items in a purse or pocket. Accordingly, instead of searching in a pocket or purse for a lighter, key, lipstick, medication (pills), or the like, a user may simply reach for her or his cell phone.

In another embodiment, an attachable pouch is designed in several formats and is constructed out of different materials: fabric, canvas, woven knit, elastic fabric neoprene, and may be configured in various sizes to accommodate the different uses (i.e., stretch material to accommodate a lipstick, pill holder, lighter, gum or any other item which the user chooses to store conveniently). In yet another embodiment, a canvas or woven material with a snap closure for a car or house key, or the like, is provided.

### BRIEF DESCRIPTION OF THE DRAWINGS

So the manner in which the above recited features of the present invention can be understood in detail, a more particular description of embodiments of the present invention, briefly summarized above, may be had by reference to embodiments, several of which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a perspective view of an exemplary embodiment of a mobile device attachment apparatus in accordance with one embodiment of the present invention;

FIG. 2 depicts a perspective view of an exemplary embodiment of a mobile device attachment apparatus in accordance with one embodiment of the present invention;

FIG. 3 depicts a perspective view of an exemplary embodiment of a mobile device attachment apparatus in accordance with one embodiment of the present invention;

FIG. 4 depicts a perspective view of an exemplary embodiment of a mobile device attachment apparatus in accordance with one embodiment of the present invention;

FIG. 5 depicts a perspective view of an exemplary embodiment of a mobile device attachment apparatus in accordance with one embodiment of the present invention;

FIG. 6 depicts a perspective view of an exemplary embodiment of a mobile device attachment apparatus in accordance with one embodiment of the present invention;

FIG. 7 depicts a front view of an exemplary embodiment of a mobile device attachment apparatus in accordance with one embodiment of the present invention;

FIG. 8A depicts a perspective view of an exemplary embodiment of a mobile device attachment apparatus in accordance with one embodiment of the present invention;

FIG. 8B depicts a side view of the exemplary embodiment of a mobile device attachment apparatus as shown in FIG. 8A;

FIG. 8C depicts a perspective view of the exemplary embodiment of a mobile device attachment apparatus as shown in FIG. 8A, with a removable article therewith;

FIG. 9A depicts a perspective view of an exemplary embodiment of a mobile device attachment apparatus in accordance with one embodiment of the present invention;

FIG. 9B depicts a front view of the exemplary embodiment of a mobile device attachment apparatus as shown in FIG. 9A;

FIG. 10 depicts a perspective view of an exemplary embodiment of a mobile device attachment apparatus in accordance with one embodiment of the present invention;

FIG. 11 depicts a perspective view of an exemplary embodiment of a mobile device attachment apparatus in accordance with one embodiment of the present invention;

FIG. 12 depicts a side view of an exemplary embodiment of a mobile device attachment apparatus in accordance with one embodiment of the present invention;

FIG. 13 depicts a side view of an exemplary embodiment of a mobile device attachment apparatus in accordance with one embodiment of the present invention;

FIG. 14A depicts a perspective view of an exemplary embodiment of a mobile device attachment apparatus in accordance with one embodiment of the present invention; and

FIG. 14B depicts a perspective view of the exemplary embodiment of a mobile device attachment apparatus as shown in FIG. 14A, with a removable article therewith.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a mobile device attachment apparatus and methods of utilizing the same. The Figures shown herewith depict exemplary embodiments of a mobile device attachment apparatus in accordance with various embodiments of the present invention. The mobile device may comprise any device suitable for embodiments of the present invention. In one embodiment, the mobile device comprises at least one of a cell phone, iPod, Blackberry, PDA, or other similar portable electronic device.

The attachment apparatus attaches to the back of any mobile device for retaining at least an article. The attachment apparatus may be connected to the mobile device by any securing means suitable for embodiments of the present invention. For example, in some embodiments, the attachment apparatus is attached to the mobile device by a pressure sensitive adhesive, an epoxy resin, a mechanical attaching mechanism (e.g., a hook and look fastener, bolt, screw, etc.), or the like, on a securing surface, which is then placed against the mobile device.

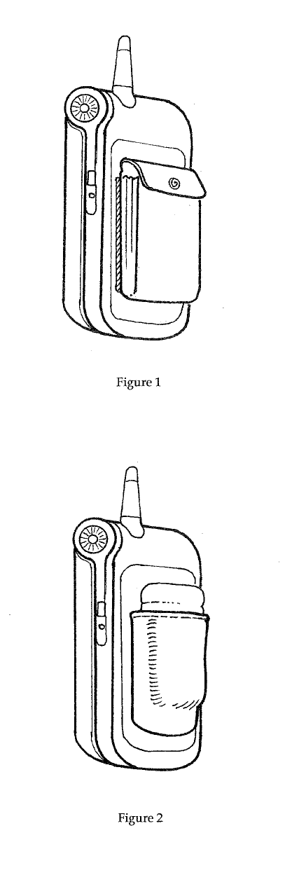

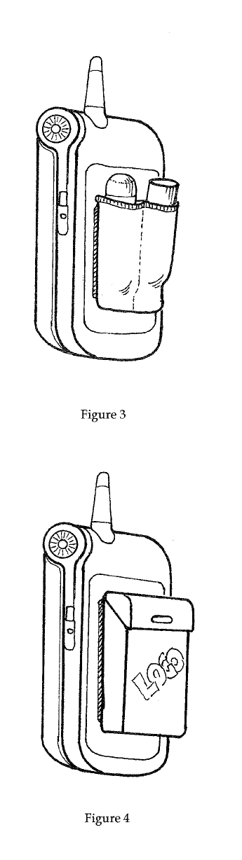

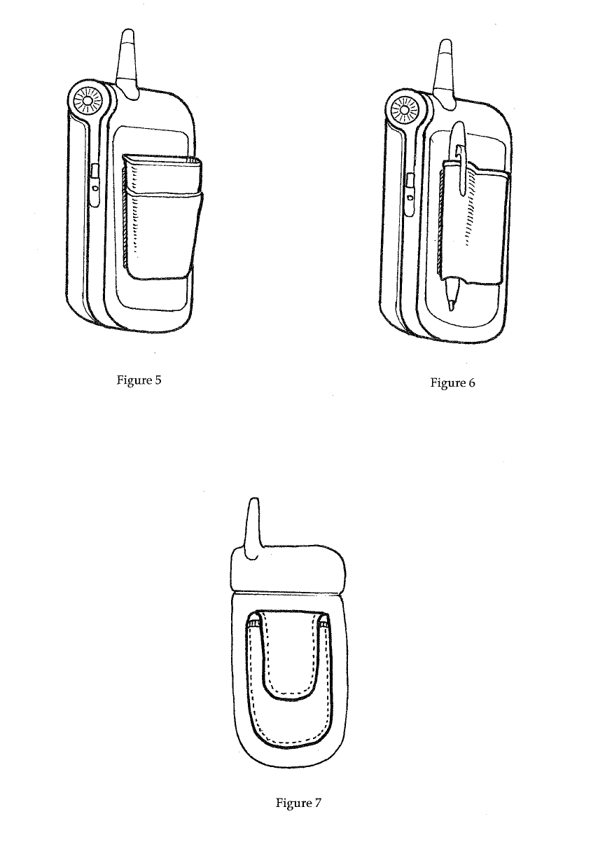

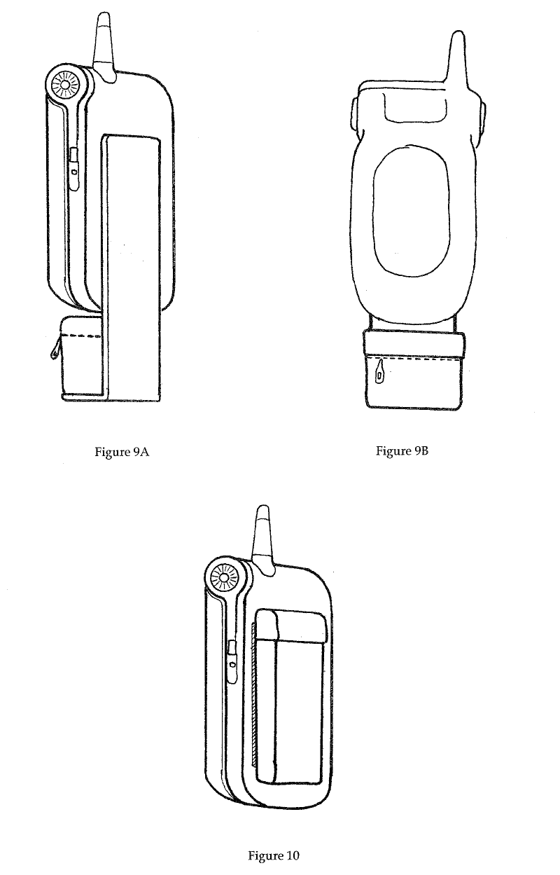

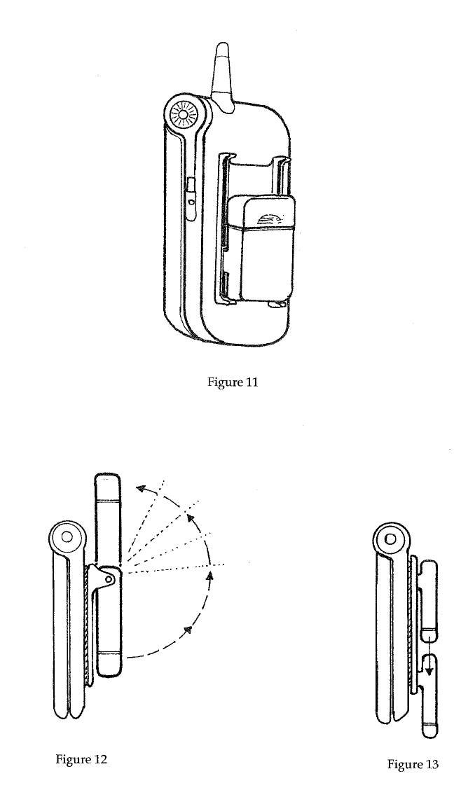

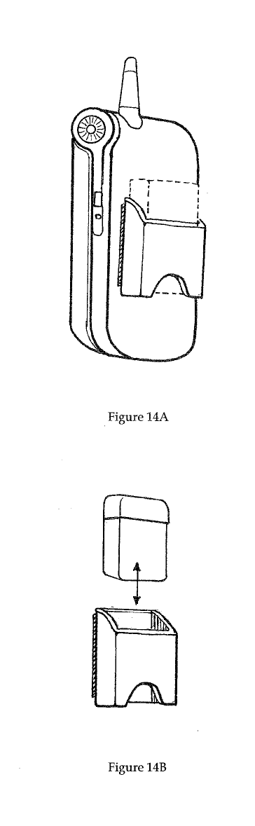

The attachment apparatus may be any of a variety of shapes and sizes, suitable for embodiments of the present invention. As shown in FIGS. 1-14, the attachment apparatus may extend out from underneath the mobile device, may be fully disposed on a backside of the mobile device, or other proximate positioning with respect to the mobile device is contemplated.

The attachment apparatus may comprise any material suitable for embodiments of the invention. In one embodiment, the attachment apparatus may comprise a metal, resilient or rigid polymer, fabric/cloth, canvas, or other suitable material.

In certain embodiments, the attachment apparatus comprises a pocket/pouch having a closure flap on top with a snap or other retention device. In such an embodiment, the sides of the attachment apparatus are folded to allow for expansion of the pocket/pouch, and will accommodate any number of items the user wants to store conveniently.

In another embodiment of the present invention, the attachment apparatus comprises a pouch made of a rubber-based material and has several divided compartments. Given the nature of its composition, in such an embodiment, the pouch may expand to accommodate various shapes of items a user wishes to carry.

In yet another embodiment, the attachment apparatus comprises a container made of a rigid plastic material with a flip up top. In such an embodiment, the outside surface of the attachment apparatus could be used for a printed message (i.e., advertisement, personal name, etc.).

In other embodiments, the attachment apparatus comprises a flexible material having several compartments to accommodate various items. In alternative embodiments, the attachment apparatus comprises an expandable material and is open top and bottom to permit larger items to be held.

As generally shown in the exemplary embodiments depicted in FIGS. 1-7, a mobile device attachment apparatus comprises a securing surface for positioning the mobile device attachment apparatus against a surface of the mobile device, the securing surface having a securing means thereon, and an article retaining pocket for securely holding at least a removable article therein. In accordance with one embodiment, the article retaining pocket is substantially defined by a front surface and a sidewall, the sidewall being integrally connected with the securing surface. Optionally, the article retaining pocket may further comprise a locking portion (e.g., a cover, lid or flap) for securing the removable article therein.

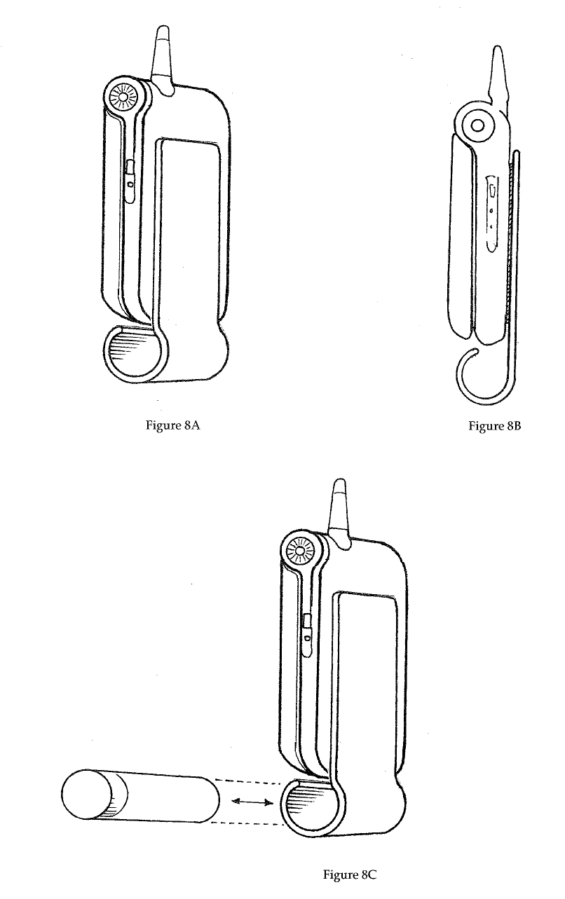

As generally shown in the exemplary embodiments depicted in FIGS. 8A-C and 9A-B, a mobile device attachment apparatus comprises a securing panel for positioning the mobile device attachment apparatus against a surface of the mobile device and for supporting an article retaining portion, the securing panel having a securing means thereon, wherein the an article retaining portion protrudes from the securing panel, adjacent to the mobile device, and securely holds at least a removable article therein. Similar to the embodiments discussed above, the article retaining portion is substantially defined by a front surface and a sidewall, the sidewall being integrally connected with the securing surface. In an alternative embodiment, the article retaining portion comprises a substantially rigid plastic member with sufficient flexibility to provide a force on an article placed therein. Optionally, the article retaining portion may further comprise a locking portion (e.g., a cover, lid or flap) for securing the removable article therein.

In yet another embodiment of the present invention, the attachment apparatus may comprise a track or retention portion and a removable portion. In such an embodiment, for example as shown in FIGS. 11-13, a mobile device attachment apparatus comprises a securing panel (or a retention portion) for positioning the mobile device attachment apparatus against a surface of the mobile device and for supporting an article retaining bracket, the securing panel having a securing means thereon, wherein the an article retaining bracket provides a limited range of motion for an article secured therein.

In other embodiments, a retention portion may be adhered or otherwise affixed to the back of the mobile device. The removable portion may either slide in/out of a track, swivel in a bracket, or otherwise move in a position relative to the retention portion. The removable portion may comprise a pouch, pocket, or other containment-type shape. In alternative embodiments, the removable portion may substantially comprise a lighter or other article or item, formed to fit within the retention portion.

The articles or items to be held by the various embodiments of the attachment apparatus may comprise any article or item which a person may generally carry on his or her person. For example, such articles or items may include, but are not limited to, keys, lipstick/chapstick, cigarettes/lighters, money/change, medication/pills, and the like. Embodiments of the present invention are not limited in scope as to which articles or items may be placed within or retained by an attachment apparatus, as disclosed herein.

While the foregoing is directed to embodiments of the present invention, other and further embodiments of the invention may be devised without departing from the basic scope thereof. It is understood that various embodiments described herein may be utilized in combination with any other embodiment described, without departing from the scope contained herein.

What is claimed is:

1. A mobile device attachment apparatus comprising:
a securing surface for positioning the mobile device attachment apparatus against a surface of the mobile device, the securing surface having a securing means thereon; and
an article retaining pocket for securely holding at least a removable article therein.

2. The mobile device attachment apparatus of claim 1, wherein the article retaining pocket is substantially defined by a front surface and a sidewall, the sidewall being integrally connected with the securing surface.

3. The mobile device attachment apparatus of claim 2, wherein the article retaining pocket further comprises a locking portion for securing the removable article therein.

4. The mobile device attachment apparatus of claim 3, wherein the locking portion comprises at least one of a cover, lid or flap.

5. The mobile device attachment apparatus of claim 1, wherein the mobile device comprises one of a mobile phone, a portable music player, or a smart phone.

6. The mobile device attachment apparatus of claim 1, wherein the securing means comprises at least one of an adhesive, epoxy resin, or a mechanical attaching mechanism.

7. The mobile device attachment apparatus of claim 6, wherein the mechanical attaching mechanism comprises at least one of a hook and loop fastener, bolt or screw.

8. The mobile device attachment apparatus of claim 1, wherein the surface of the mobile device is a rear surface, opposing a primary user interface of the mobile device.

9. A mobile device attachment apparatus comprising:
a securing panel for positioning the mobile device attachment apparatus against a surface of the mobile device and for supporting an article retaining portion, the securing panel having a securing means thereon;
wherein the an article retaining portion protrudes from the securing panel, adjacent to the mobile device, and securely holds at least a removable article therein.

10. The mobile device attachment apparatus of claim 9, wherein the article retaining portion is substantially defined by a front surface and a sidewall, the sidewall being integrally connected with the securing surface.

11. The mobile device attachment apparatus of claim 10, wherein the article retaining portion further comprises a locking portion for securing the removable article therein.

12. The mobile device attachment apparatus of claim 12, wherein the locking portion comprises at least one of a cover, lid, or flap.

13. The mobile device attachment apparatus of claim 9, wherein the mobile device comprises one of a mobile phone, a portable music player, or a smart phone.

14. The mobile device attachment apparatus of claim 9, wherein the securing means comprises at least one of an adhesive, epoxy resin, or a mechanical attaching mechanism.

15. The mobile device attachment apparatus of claim 9, wherein the surface of the mobile device is a rear surface, opposing a primary user interface of the mobile device.

16. A mobile device attachment apparatus comprising:
a securing panel for positioning the mobile device attachment apparatus against a surface of the mobile device and for supporting an article retaining bracket, the securing panel having a securing means thereon;
wherein the an article retaining bracket provides a limited range of motion for an article secured therein.

17. The mobile device attachment apparatus of claim 16, wherein the mobile device comprises one of a mobile phone, a portable music player, or a smart phone.

18. The mobile device attachment apparatus of claim 16, wherein the securing means comprises at least one of an adhesive, epoxy resin, or a mechanical attaching mechanism.

19. The mobile device attachment apparatus of claim 18, wherein the mechanical attaching mechanism comprises at least one of a hook and loop fastener, bolt or screw.

20. The mobile device attachment apparatus of claim 16, wherein the surface of the mobile device is a rear surface, opposing a primary user interface of the mobile device.
